(19) United States
(12) Patent Application Publication
(10) Pub. No.: US 2008/0175228 A1
(43) Pub. Date: Jul. 24, 2008

(54) Proactive quality assessment of voice over IP calls systems

(75) Inventors: Shisen Chang, San Jose, CA (US); Henry W. Lambert, Campbell, CA (US); Philip F. Sherburne, Morgan Hill, CA (US); Xi Zhao, Petaluma, CA (US)

Correspondence Address: THE LAW OFFICES OF BRADLEY J. BEREZNAK, 800 WEST EL CAMINO REAL, SUITE 180, MOUNTAIN VIEW, CA, 94040, US

(73) Assignee: Cisco Technology, Inc., San Jose, CA (US)

(21) Appl. No.: 11/657,331

(22) Filed: Jan. 24, 2007

(51) Int. Cl. H04L 12/66

(52) U.S. Cl. 370/352

(57) ABSTRACT

In one embodiment, a system includes a database that stores administrative information of an Internet protocol private branch exchange (IP-PBX). The administrative information correlates to a geographic configuration of endpoint devices connected via low bandwidth network links. A node is operable to access the database in order to retrieve and analyze the administrative information. Following the analysis, the node generates a test call pattern that is limited to test calls between the endpoint devices connected across the low bandwidth network links. The node is further operable to place the test calls of the test call pattern and acquire voice quality information therefrom. It is emphasized that this abstract is provided to comply with the rules requiring an abstract that will allow a searcher or other reader to quickly ascertain the subject matter of the technical disclosure.

### FIELD OF THE INVENTION

The present disclosure relates to the field of voice communications over a data network using the Internet Protocol (IP).

### BACKGROUND OF THE INVENTION

Voice quality problems are commonly encountered in voice over IP (VoIP) calls placed between IP phones connected over a low bandwidth connection such as a wide-area network (WAN). In contrast, voice quality issues generally do not arise in a network connection with sufficient bandwidth such as a local-area network (LAN). The voice quality problems that occur in IP-based connections include echo from endpoint device to endpoint device (e.g., IP phones), voice chopping or breaking, and distorted, incomplete, or delayed voice transmissions. Voice quality assessments are usually manually or automatically done between IP packet transmitters, such as IP phones and network routers for troubleshooting call quality issues. However, voice quality assessments in networks without bandwidth issues (e.g., a LAN) are usually unnecessary.

Various tools exist to detect poor voice quality calls and/or to report poor voice quality statistics. By way of example, users of Cisco® Call Manager IP phones who are experiencing echo or other voice quality problem may activate a Quality Report Tool (QRT) that allows for the measurement and reporting of voice-quality and network characteristics in order to optimize performance. Cisco's Call Manager is a software-based call processing component that extends enterprise telephony features and functions to packet telephony network devices such as IP phones, media processing devices, voice-over-IP (VoIP) gateways, and multimedia applications. One drawback with this approach is that the tests and measurements tend to be very complicated. Another drawback with the QRT approach is that voice quality problems are only detected and addressed after they actually occur.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 illustrates an example IP-based voice system.

FIG. 2 illustrates an example method for proactive testing of endpoint-to-endpoint calls.

FIG. 3 illustrates an example network node.

### DESCRIPTION OF EXAMPLE EMBODIMENTS

In the following description specific details are set forth, such as device types, configurations, specific methods, etc., in order to provide a thorough understanding of the present invention. However, persons having ordinary skill in the relevant arts will appreciate that these specific details may not be needed to practice the present invention.

In the context of the present disclosure, an IP-PBX is a private branch exchange (telephone switching system within an enterprise) that switches calls between VoIP (voice over Internet Protocol or IP) users on local lines while allowing users to share a certain number of external phone lines. An IP-PBX may also switch calls between a VoIP user and a traditional telephone user, or between two traditional telephone users in the same way that a traditional PBX does. In the context of the present application, an endpoint may comprise a telephone device (such as an end-user IP phone), a personal digital assistant (PDA), a laptop or notebook computer, or any other device (including a gateway device), network node, component, element, or object capable of initiating or participating in voice or packet-data exchanges via a communication network in accordance with the protocols and methods described herein.

In one embodiment, a call processing component or entity utilizes information stored in one or more administrative databases, such as a database associated with an IP-PBX system of an enterprise, to place test calls from user endpoint devices in order to maximize the chance of proactively discovering voice quality problems for calls placed over IP-based connections between different enterprise branch sites. The administrative information is selected to correlate highly to a geographic configuration (i.e., locations or regions) of end-user telephone devices connected via a network connection that is susceptible to voice quality problems (e.g., a low bandwidth link). This information may comprise call-admission-control related information, codec-filter related information, or information based on site names, sub-networks, or a topology of the network.

In a specific embodiment, a site specific test call pattern is automatically and periodically executed over links with voice quality concerns (e.g., low bandwidth WAN links) by a call processing component running on a network node under IP-PBX system control. These limited test calls placed between end-user phones provide precise voice quality assessment of what end-users would experience on a real call over the same network links. A reporting tool provides automatic notification to an administrator who may then take proactive actions to ensure a high quality of voice communications over the network.

In one implementation, the automated tools, routines and methods of operation described herein are embodied in software or hardware (firmware) installed in an IP communications system comprising a version of Cisco System's Call Manager call processing product. Alternative embodiments of the present invention may be implemented in PBX, telephony, telephone, and other telecommunications systems. Similarly, the signaling path utilized for transmission of commands, messages, and signals for establishing, moderating, managing, and controlling the conference session may be across any network resources. Practitioners in the art will understood that the software or firmware installed in the systems and components mentioned above may be adapted or modified to implement the functions and capabilities described herein.

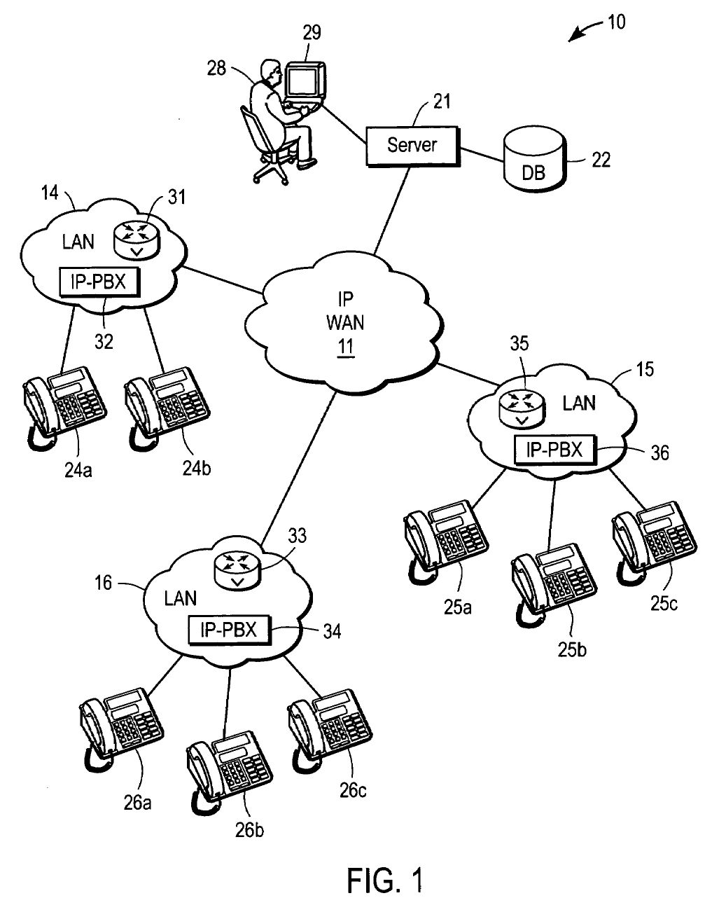

FIG. 1 illustrates an example IP-based voice system 10 with an IP WAN 11 that provides connections between endpoint devices (end-users) of different geographically located branches. The different branches or sub-networks are represented by LANs 14-16, each of which is shown including a voice gateway device (e.g., router), an IP-PBX, and a plurality of IP phones. For example, LAN 14 is shown including a gateway 31, IP-PBX 32 and IP phones 24a & 24b; LAN 15 includes a gateway 35, IP-PBX 36 and IP phones 25a-25c; with LAN 16 having a gateway 33, IP-PBX 34 and IP phones 26a-26c. Voice gateways 31, 33 and 35 may be utilized to connect calls via a PSTN in the event that voice quality drops below a certain predetermined threshold level for connections across WAN 11. Connections between any two IP phones may be made across WAN 11 directly via the local IP-PBX elements and/or via the associated voice gateway devices.

It is appreciated that the IP-PBX components shown in FIG. 1 may be implemented as call management clusters administratively managed via a server 21, which itself may implement a call processing component or call management routines. A system administrator 28 is shown connected with server 21 via a node (PC) 29. A database 22 is also shown connected with server 21. In an alternative embodiment, database 22 may be accessed by server 21 (or other call management cluster nodes). Database 22 stores administrative information which may include call-admission-control related information, codec-filter related information, and/or information based on site names, sub-networks, logical divisions of the voice network, or other network topological information associated with the IP-PBX system distributed among the various branches (LANs).

For instance, included in database 22 may be information that determines which codec to use when calls are placed within or between a pair of different geographically located branches. Voice gateway configurations may also be stored in database 22 along with a listing of other resources of the IP-PBX system of the enterprise. Practitioners in the art will appreciate that the information stored in database 22 can be collected from a variety of sources or configured in different ways. For example, information for storage in database 22 may be collected from ordinary network topology discovery, e.g., via Cisco Discovery Protocol (CDP) and/or Simple Network Management Protocol (SNMP) topology discovery routines. Database information may also be obtained from call statistics history data or via manually configuration by a network manager or administrator.

In accordance with the embodiment of FIG. 1, sever 21 executes an automated routine that begins with an intelligent analysis of the network information contained in administrative database 22. Test call generation is based on network configuration information such that only calls are placed over WAN 11 between endpoints of different branches. In other words, server 21 generates a test call pattern that excludes calls between endpoints connected within the same LAN. A test call pattern based on an intelligent analysis of IP-PBX system configuration improves testing efficiency and also increases test accuracy by narrowing down system bottlenecks (e.g., WAN 11 in FIG. 1).

Additionally, test calls are placed on real end-user phone devices (e.g., IP phones and (e.g., VoIP gateways) to observe voice quality on actual network conditions. Test calls may be conducted for a fully meshed test coverage (e.g., each possible pairing of endpoints connected over WAN 11) call scenario. In the context of the present disclosure, a full mesh is defined as a mesh that connects endpoint phone devices connected via one or more low bandwidth links (e.g., a WAN) or any other network connection susceptible to voice quality problems. In other words, any end-user phone located in a particular sub-network may represent that sub-network for test calling purposes across the voice quality susceptible network links. For example, a fully meshed test call scenario for the configuration of FIG. 1 involves placing a series of test calls from either one of IP phones 24a or 24b to any one of phones 25a-25c of LAN 15, and from either one of IP phones 24a or 24b to any one of phones 26a-26c of LAN 16. Furthermore, test calls may be placed on a regular (scheduled) basis.

It is appreciated that server 21 does not place the actual phone calls of the test pattern; rather, server 21 generates the test call pattern and then instructs IP-PBX 32, 34 and 36 to set up and execute the calls between the appropriate or designated endpoints.

In a specific embodiment, two interfaces of each LAN may be leveraged for test call generation: a CTI interface for test calls placed against end-user phones, and an IP Service Level Agreement (IPSLA) interface. A CTI interface is a telephony resource that creates a portal through which interoperable telephony components communicate with one another. A CTI interface operates by generating, sending, receiving, and interpreting messages containing status information and requests for services to be performed. An IPSLA probe, for example, is typically utilized to monitor specific network devices for packet transmissions between any two IPSLA-enabled points (e.g., gateways) across a network.

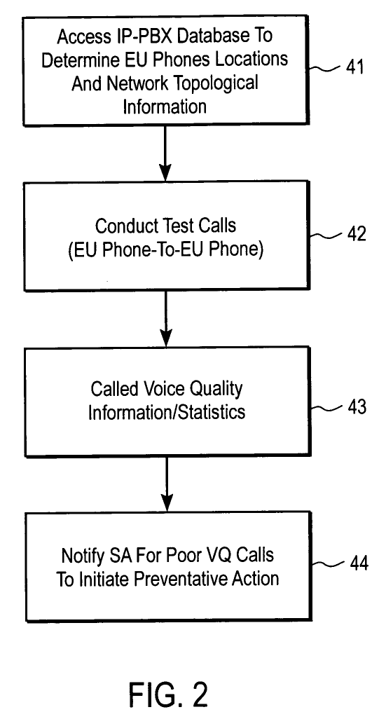

FIG. 2 illustrates an example method for proactive testing of endpoint-to-endpoint calls. The process begins at block 41 with the accessing of the IP-PBX administrative database to obtain relevant information regarding the locations of IP phones in the enterprise, network topology, and other system configuration information. This information is processed by one or more processors in a server or other network node to make an intelligent selection of test calls between those end-users connected over network connections susceptible to voice quality problems (e.g., WAN connections).

After intelligent analysis of IP-PBX system configuration information, test calls are conducted using real endpoint devices (e.g., end-user phones). This is shown occurring in block 42. VoIP gateways may also be included in the test coverage. In one embodiment, a fully meshed test coverage is implemented. Testing load may be adjusted dynamically so that test calls do not interfere with or impact existing call processing functions. In a specific embodiment, the volume (i.e., number) of test calls being placed may be automatically increased or decreased depending on current IP-PBX load and/or calculated already-consumed bandwidth between endpoint devices to be tested. In another embodiment, test calls may also be scheduled to take place with in certain frequency and/or within a particular time slot.

During testing, voice quality information is acquired in real-time (block 43). For example, voice quality information may be obtained from phone devices' call statistics access interface, call managerial/call processing components, and/or VoIP gateway internal/external program interfaces. Mean opinion scores (MOS) e.g., K-factor MOS, generated on the IP phones, VoIP gateways, and/or other nodes may also be used in voice quality assessment. K-factor is an endpoint MOS estimation algorithm defined in International Telecommunications Union (ITU) standard P.VTQ that represents a weighted estimate of average user annoyance due to distortions caused by effective packet loss such as dropouts and warbles. MOS relates to the output of a listening experiment that uses a five point perceptual evaluation of speech quality (PESQ) scale as defined in ITU standard P.862.1 for end-to-end speech quality assessment of narrow band telephone networks and speech codecs. It is a general estimator and is used to estimate the mean value of a PESQ population for a specific impairment pattern to comply with the P.VTQ standard. ITU standard P.VTQ is a standard model for the assessment of voice transmission quality from protocol analysis information in IP networks.

Once voice quality information and statistics have been collected from the test calls, notifications and/or call traces for preventative actions may be automatically generated for poor voice quality calls (block 44). For instance, a notification in response to a poor voice quality call may be sent automatically to the system administrator. A poor voice quality call may be defined as one which fails to meet an acceptable speech quality assessment level (e.g., a minimum K-factor MOS). Notification may be sent via any appropriate transmission medium/channel (e.g., email, instant messaging, paging, IVR calls, alert, etc.) In embodiments where it is available, call trace information may be collected automatically by the system and included in a detailed report sent to the system administrator. The voice quality information and statistics may also be stored in a database for archival purposes and later retrieval. After receiving and analyzing this information, the system administrator may initiate preventative action as early as possible in order to avoid voice quality problems in later-placed calls between actual end-users.

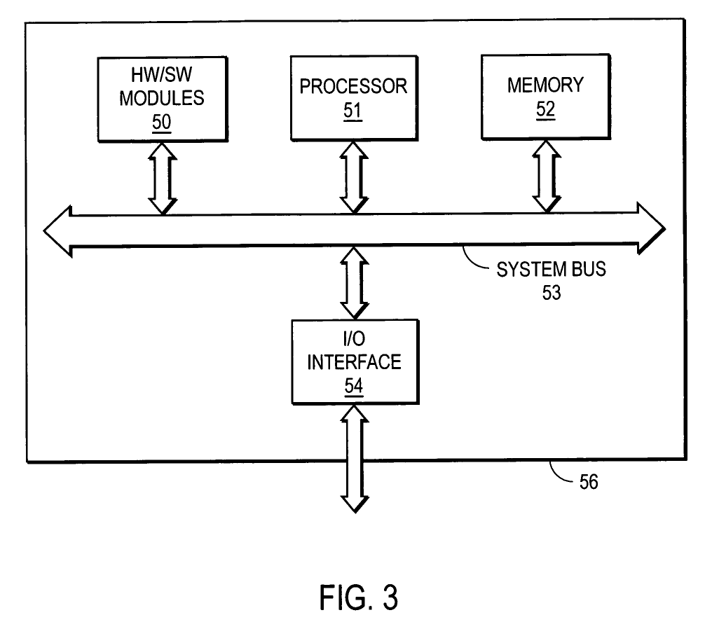

FIG. 3 is a generalized block diagram showing an example network node 56, such as may comprise any of the devices or nodes shown or described in conjunction with FIG. 1 or 2. Node 56 includes a processor subsystem 51 coupled with a memory unit 52, one or more hardware/software modules 50, and an input/output (I/O) interface 54 via a system bus 53. Modules 50 may include software, firmware, or logic embedded in hardware for implementing any of the functions described herein, e.g., those functions associated with periodic generating and running test calls over WAN connections, acquiring voice quality information, and sending out appropriate notifications to initiate preventative actions.

It is appreciated that any call management or call processing component utilized by node 56 may comprise separate hardware devices coupled to the system bus 53, or, alternatively, implemented as software programs or modules 50 that run on one or more processors of subsystem 51. In other words, the methods and functions described above may be implemented as separate hardware devices, memory locations (storing executable code), firmware devices, software modules, or other machine-readable devices. (In the context of the present application, therefore, the term “module” is to be understood as being synonymous with both hardware devices and computer-executable software code, programs or routines.)

It should be understood that elements of the present invention may also be provided as a computer program product which may include a machine-readable medium having stored thereon instructions which may be used to program a computer (e.g., a processor or other electronic device) to perform a sequence of operations. Alternatively, the operations may be performed by a combination of hardware and software. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer or telephonic device to a requesting process by way of data signals embodied in a carrier wave or other propagation medium via a communication link (e.g., a modem or network connection).

Additionally, although the present invention has been described in conjunction with specific embodiments, numerous modifications and alterations are well within the scope of the present invention. For instance, practitioners in the telephony arts will appreciate that proactive testing operations described above are not limited to any specific network configuration or the use of certain network devices. For example, alternative embodiments may rely upon a centralized system in which there may be only one IP-PBX server hosting the entire communications network. In still other implementations, ordinary routers may be utilized rather than voice-enabled routers. In other words, the methods described above are applicable to any telephony network configuration that involves endpoint devices connected via low bandwidth links (e.g., a WAN) or any other network connections susceptible to voice quality problems. Accordingly, the specification and drawings are to be regarded in an illustrative rather than a restrictive sense.

We claim:

1. A method comprising:
(a) accessing administrative information stored in a database associated with an Internet protocol private branch exchange (IP-PBX), the administrative information correlating to a geographic configuration of end-user telephone devices connected via one or more network connections susceptible to voice quality problems;
(b) generating a test call pattern based on the administrative information, the test call pattern including a set of test calls between the end-user telephone devices connected across the one or more network connections;
(c) placing the test calls; and
(d) acquiring voice quality information from the test calls.

2. The method of claim 1 wherein the administrative information comprises call-admission-control related information or codec-filter related information.

3. The method of claim 1 wherein the administrative information comprises a plurality of site names.

4. The method of claim 1 wherein the administrative information comprises a plurality of sub-networks.

5. The method of claim 1 wherein the administrative information comprises a network topology.

6. The method of claim 1 wherein a first set of the end-user telephone devices is associated with a first local area network (LAN), and a second set of the end-user telephone devices is associated with a second LAN.

7. The method of claim 1 further comprising (e) notifying an administrator when the voice quality information includes data indicating that one of the test calls fails to meet a minimum speech quality assessment level.

8. The method of claim 7 further comprising periodically repeating (c)-(e).

9. Logic encoded in one or more media for execution and when executed is operable to:
retrieve administrative information associated with an Internet protocol private branch exchange (IP-PBX) from a database, the administrative information correlating to a geographic configuration of endpoint devices connected via one or more network connections susceptible to voice quality problems;
generate a test call pattern based on an analysis of the administrative information, the test call pattern being limited to test calls between the endpoint devices connected across the one or more network connections; and
place the test calls of the test call pattern; and
acquire voice quality information from the test calls.

10. The logic of claim 9 wherein the logic, when executed, is further operable to store the voice quality information.

11. The logic of claim 9 wherein the logic, when executed, is further operable to notify an administrator when the voice quality information includes data indicating that one of the test calls fails to meet a minimum speech quality assessment level.

12. The logic of claim 11 wherein the data comprises a voice quality score.

13. The logic of claim 11 wherein the voice quality information is acquired in real-time from a call processing component associated with the IP-PBX.

14. The logic of claim 9 wherein the test calls are placed with a certain frequency.

15. The logic of claim 9 wherein the test call pattern comprises a fully meshed call pattern.

16. A system comprising:
a database that stores administrative information of an Internet protocol private branch exchange (IP-PBX), the administrative information correlating to a geographic configuration of endpoint devices connected via one or more network connections susceptible to voice quality problems; and
a node operable to access the database to retrieve and analyze the administrative information to generate a test call pattern that is limited to test calls between the endpoint devices, the node being further operable to instruct the test calls of the test call pattern and acquire voice quality information therefrom.

17. The system of claim 16 wherein the node is further operable to automatically notify an administrator when the voice quality information includes data indicating that one of the test calls fails to meet a minimum speech quality assessment level.

18. The system of claim 16 wherein the node is further operable to automatically increase or decrease a volume of the test calls in response to a current load of the IP-PBX.

19. The system of claim 16 wherein the administrative information comprises call-admission-control related information or codec-filter related information.

20. The system of claim 16 wherein the administrative information comprises a plurality of site names.

21. The system of claim 16 wherein the administrative information comprises a plurality of sub-networks.

22. The system of claim 16 wherein the administrative information comprises a network topology.

23. The system of claim 16 wherein the node comprises the IP-PBX.

24. A system comprising:
a database to store administrative information of an Internet protocol private branch exchange (IP-PBX), the administrative information correlating to a geographic configuration of endpoint devices connected via one or more network connections susceptible to voice quality problems; and
means for accessing the database to retrieve and analyze the administrative information, the means also for placing test calls based on the administrative information, the test calls being limited to a full mesh coverage of the endpoint devices connected across the one or more network connections, the means also for acquiring voice quality information from the test calls and notifying an administrator when the voice quality information includes data indicating that one or more of the test calls fails to meet a minimum speech quality assessment level.
